(19) United States
(12) Patent Application Publication
(10) Pub. No.: US 2017/0291182 A1
(43) Pub. Date: Oct. 12, 2017

(54) AIR SPRAY DEVICE FOR HETEROGENEOUS MIXTURE COATING SOLUTION, USING PULSE OPENING AND CLOSING OPERATIONS OF NEEDLE VALVE

(71) Applicants: Byung Kook YOON, Seoul (KR); TTNS, Gyeonggi-do (KR)

(72) Inventors: Byung Kook YOON, Seoul (KR); Ju Yeop JANG, Seoul (KR); Jeong Seop YOON, Seoul (KR)

(21) Appl. No.: 15/516,614

(22) PCT Filed: Oct. 16, 2014
(86) PCT No.: PCT/KR2014/009745

§ 371 Date: Apr. 3, 2017

(51) Int. Cl. B05B 7/04; B05B 7/12

(52) U.S. Cl. CPC B05B 7/04; B05B 7/12

(57) ABSTRACT

The present invention relates to an air spray device for a heterogeneous mixture coating solution without a separate stirring device. The air spray device 100 comprises: a main body 110 provided with a heterogeneous mixture coating solution inlet 111 and an inlet 112 for compressed air from the outside; an extension block 120 coupled in a downwardly extended shape at the lower end of the main body; a nozzle assembly 130 coupled at the lower end of the extension block; a communication path 140 vertically formed in the centers of the main body, the extension block and the nozzle assembly; a needle valve 150 provided inside the communication path; and a plunger 160 formed in a plate shape to be positioned in proximity to the bottom side of the communication path of the extension block to stir the heterogeneous mixture coating solution.

### FIELD OF TECHNOLOGY

The present invention relates to an air spray device for uniformly coating a surface to be coated with a heterogeneous mixture coating solution, and relates to an air spray device for a heterogeneous mixture coating solution using a pulse opening/closing operations of needle valve, capable of inhibiting the cohesion and precipitation of powder contained in the heterogeneous mixture coating solution without providing a separate stirring device.

### BACKGROUND OF INVENTION

In general, an air spray device operates in a principle that the coating solution is extracted by negative pressure by fast flow of compressed air and discharged, and the coating solution discharged through nozzle turns into minute particles at the end of nozzle by fast-flowing air to be sprayed.

An example of such air spray devices has been disclosed in a Korean Patent Application Publication 10-2012-0028237.

As shown in FIGS. 1 and 2, the air spray device 1 includes a main body 10 provided with a pressurized coating solution inlet 11 for being supplied with coating solution from outside and a compressed air inlet 12 for being supplied with compressed air from outside, an extension block 20 extending downwards from a lower end of the main body 10, and a nozzle assembly 30 engaged to a lower end of the extension block 20. The main body 10, the extension block 20, and the nozzle assembly 30 provide a communication path 40 in common.

In the communication path 40 of the main body 10 is installed a needle valve 50 so as to move elastically up and down, determining opening and closing of a coating solution discharge hole 31 for spraying the coating solution. And at the top end of the main body 10 is provided a stroke-controlling member 60 for adjusting amplitude of the needle valve 50, and in the main body 10 is installed a piston member 70 for receiving rising force from compressed air and delivering the rising force to the needle valve 50.

On the other hand, if compressed air is introduced into the main body 10 from the compressed air inlet 12, the lower portion of the needle valve 50 inserted into the nozzle assembly 30, rises by the operation of the piston member 70, and opens the coating solution discharge hole 31 formed at the lower end of the nozzle assembly 30, and if the introduction of compressed air is stopped, it falls down due to elasticity and closes the coating solution discharge hole 31.

Therefore, if the coating solution discharge hole 31 is opened, the coating solution is introduced from the pressurized coating solution inlet 11, passes by the extension block 20, and is sprayed through the coating solution discharge hole 31.

On the other hand, in order to impart a special function to coating layer, heterogeneous mixture coating solution including metal/nonmetal powder performing special functions has been applied in various state-of-art technical fields recently.

For example, in the field of fuel cell, the heterogeneous mixture coating solution including nano-sized platinum powder is being used for coating both surfaces of membrane electrode assembly (MEA) with catalyst, and the heterogeneous mixture coating solution including nano-sized carbon powder is being used for coating both surfaces of gas diffusion layer (GDL) with catalyst, and the heterogeneous mixture coating solution including phosphor powder having a size of 3 μm to 6 μm for coating phosphor on blue LED for obtaining white light in the field of LED.

However, the above conventional air spray device is not suitable to spray heterogeneous mixture coating solution. For the powder coagulates or settles in the spray device due to electrophoresis or gravity, but the conventional spray device cannot prevent such coagulation or settlement, so that the powder for special function cannot be sprayed evenly, failing to achieve high efficiency.

Therefore, in order to solve the above problems, various types of air spray devices are being developed, which make the heterogeneous mixture coating solution supplied into the main body maintain the dispersing state of powder maximally by installing a stirrer capable of stirring the heterogeneous mixture coating solution in the pressure vessel or by installing a ultrasonic generator capable of stirring by stimulating the heterogeneous mixture coating solution in the pressure vessel periodically with ultrasonic wave, or by making the main body piped for circulation-type fluid and circulating the heterogeneous mixture coating solution in the pressure vessel forcefully using a pneumatic pump.

However, such air spray devices for heterogeneous mixture coating solution are effective in maintaining the dispersing state of powder in the pressure vessel or the main body of air spray device where the piping of circulation-type fluid is installed, but since its structural feature makes powder still congested in an extension block extending long downwards from a lower end of the main body and nozzle assembly, it cannot be expected to maintain the dispersing of powder.

Therefore, it is the present situation that such air spray devices for heterogeneous mixture coating solution are much more expensive to manufacture and complicated in structure compared to the conventional air spray devices, making the benefit to obtain ignorable.

On the other hand, since the above air spray devices for heterogeneous mixture coating solution use lots of compressed air as a power to spray, the phenomenon of bounce back of sprayed coating particles decreasing the efficiency of coating seriously, and therefore in cases requiring high coating efficiency due to exceptionally high material cost and the like, pulse-controlling spray type is being applied, which controls up-and-down movements of needle valve very fast and performs coating operation intermittently. However, in the pulse-controlling spray type, due to mechanical vibration generated during performing fast pulse operation of needle valve, the lower portion of the needle valve shakes from side to side, and thus the discharge hole of coating solution cannot be opened or closed precisely, resulting in lowering of coating quality such as leaking eventually.

### DETAILED DESCRIPTION OF INVENTION

### Problems to Solve

The invention is to solve the above problems and to provide an air spray device for heterogeneous mixture coating solution, which minimizes the cost increase, simplifies the structure, and also maintains the dispersing state of powder up to the discharge hole of coating solution of the air spray device, compared to the conventional air spray devices for heterogeneous mixture coating solution.

Also, the invention is to provide an air spray device for heterogeneous mixture coating solution, which minimizes the shaking of needle valve from side to side even though the needle valve performs pulse operation up and down rapidly, making the discharge hole for coating solution open and close precisely.

### Solutions to Problems

In order to achieve the goals of the invention, an air spray device for heterogeneous mixture coating solution, using pulse opening and closing operations of needle valve comprises: a main body provided with a heterogeneous mixture coating solution inlet and a compressed air inlet from outside; an extension block engaged with a lower end of the main body in a form extending downwards; a nozzle assembly engaged with a lower end of the extension block and formed with a discharge hole of coating solution for discharging the heterogeneous mixture coating solution passing the extension block to outside; a communication path formed vertically at the center of the main body, the extension block, and the nozzle assembly; a needle valve that is installed in the communication path, receiving rising and falling force from the main body, and performing pulse opening and closing operations for opening and closing the discharge hole for coating solution; and a plunger formed in a planar form, inserted to the needle valve so as to be disposed close to a floor side of the communication path of the extension block, performing pulse opening and closing operations with the needle valve, and generating fluid resistance in the communication path, so as to stir the heterogeneous mixture coating solution.

On the other hand, the plunger may comprise an outer diameter surface encountering closely an inner diameter surface of the communication path and a separating portion forming a separating gap with respect to the inner diameter surface of the communication path, so as to adjust magnitude of the fluid resistance.

Also, the plunger may be a disc with an outer diameter close to the inner diameter surface of the communication path, and at least one groove portion penetrating for top to bottom is formed in the plunger, so as to adjust magnitude of the fluid resistance.

In such a case, the groove portion may be formed so that a plurality of grooves are formed along the outer diameter surface with even intervals.

### Advantages of Invention

The invention formed as in the above can be realized without expensive complicated structure as in prior arts because the plunger installed at a side of the needle valve opens and closes in pulse along with the needle valve, so as to generate fluid resistance in the communication path and stir the heterogeneous mixture coating solution, and also the coating quality is increased much since the dispersed state of the powder can be maintained up to the discharge hole of coating solution.

### BRIEF DESCRIPTION OF DRAWINGS

FIG. 1 is a perspective view of a conventional air spray device.

FIG. 2 is a cross-sectional view of FIG. 1.

FIG. 3 is a perspective view of an air spray device for heterogeneous mixture coating solution of the invention.

FIG. 4 is an exploded perspective view of FIG. 3.

FIG. 5 is a cross-sectional view of FIG. 3.

FIG. 6 is a plan view of a plunger of the invention, showing a state formed with groove portion.

FIG. 7 is a cross-sectional view of the invention, showing a state applied with the plunger of FIG. 6.

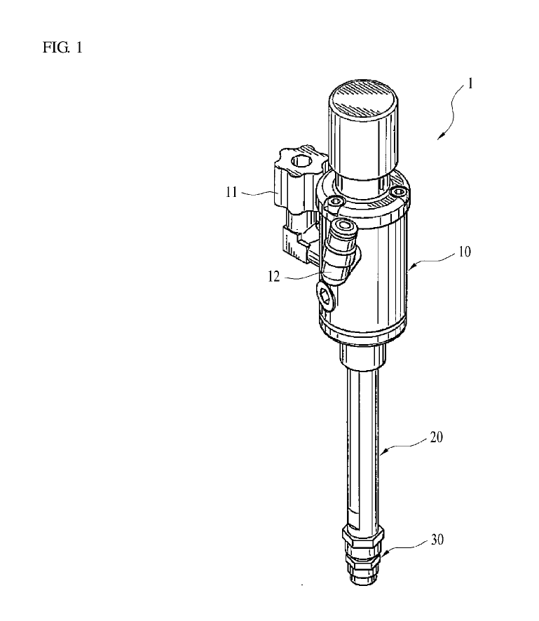

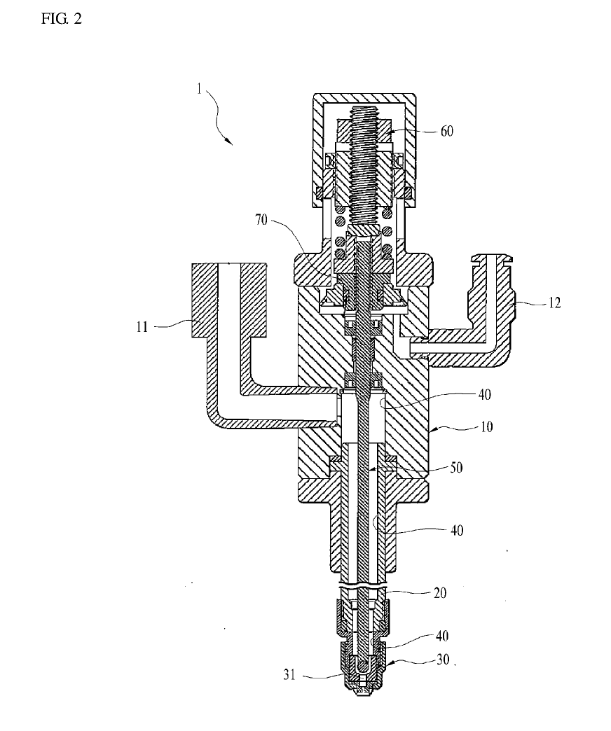

### DETAILED DESCRIPTION OF EMBODIMENTS OF INVENTION

Features and advantages of the invention will be seen clearly by the detailed description of preferred embodiments referring to the attached figures. First of all, the terms and words used in this specification and the claims must be interpreted in meanings and concepts adapted to the spirit of technology of the invention in the principle that the inventor is able to define the concepts of terms in order to explain the invention to the best.

Below, in the following detailed description of an embodiment of the invention referring to the drawings, equivalent numerals have been used for equivalent structures, and the explanation will be mainly about the different portions for clarity.

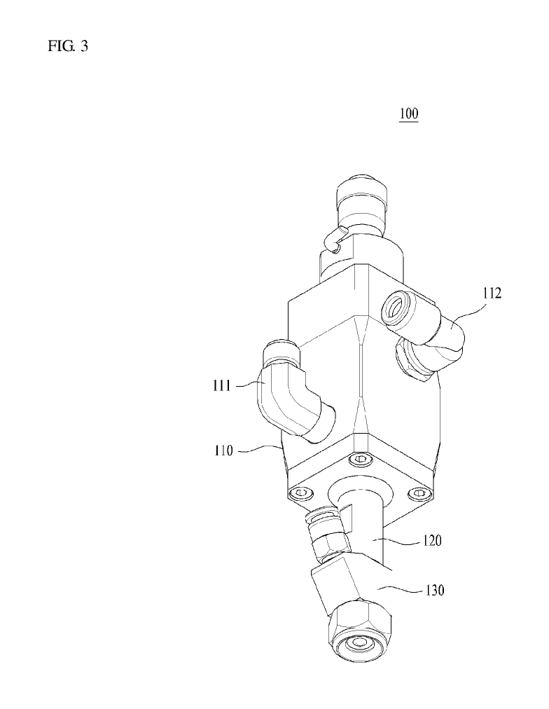

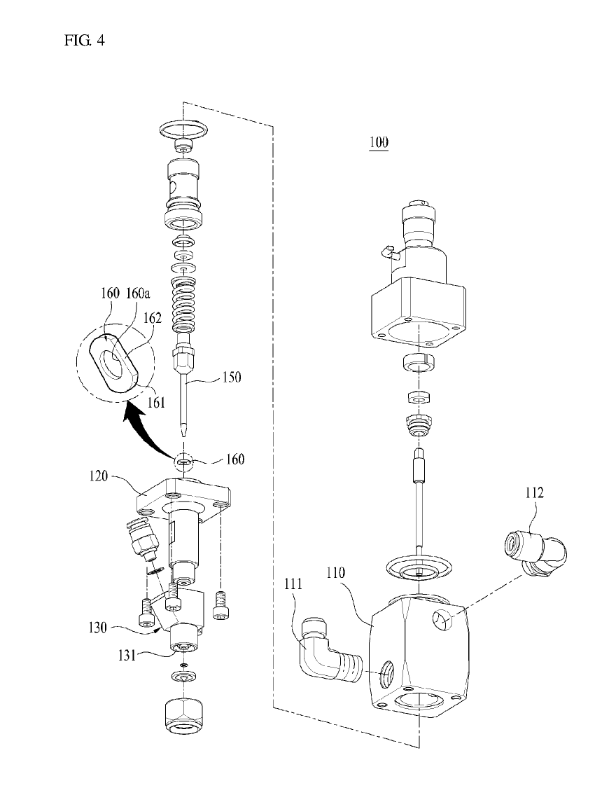

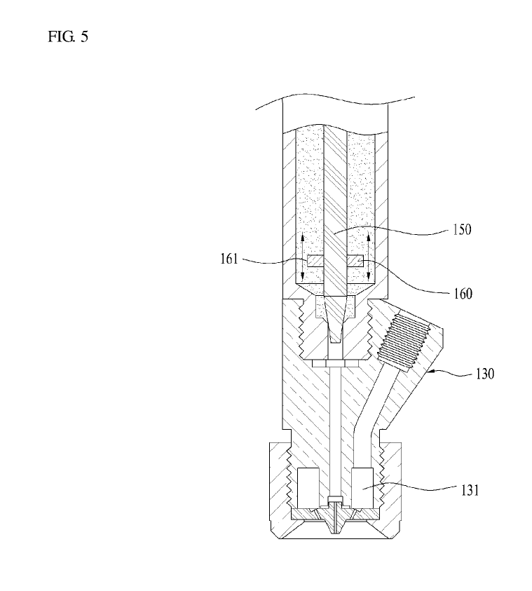

As shown in FIGS. 3 to 5, the air spray device 100 of the invention provides basically the main body 110, the extension block 120, and the nozzle assembly 130.

The main body 110 provides a heterogeneous mixture coating solution inlet 111 and a compressed air inlet 112 from outside, and the extension block 120 engages in a form of extending downwards from the lower end of the main body 110, and the nozzle assembly 130 is engaged to the lower end of the extension block 120 and the coating solution discharge hole 131 is formed at the nozzle assembly 130 for discharging to the outside the heterogeneous mixture coating solution passing through the extension block 120.

And, the communication path 140 is formed vertically through the center of the main body 110, the extension block 120, and the nozzle assembly 130, and in the communication path 140 is installed the needle valve 150, which receives rising and falling force from the main body 110 and operates opening and closing motion in pulse, so as to open and close the coating solution discharge hole 131.

Since the main body 110, the extension block 120, the nozzle assembly 130, and the needle valve 150 as shown in the above are similar to the prior arts, the detailed description of them are going to be omitted.

According to the invention, in the needle valve 150 is inserted the plunger 160. The plunger 160 is inserted at one portion of the needle valve 150, operates opening and closing motion, and generates fluid resistance in the communication path 140, so as to stir the heterogeneous mixture coating solution.

The plunger 160 is preferably installed close to the floor side of the communication path 140 of the extension block 120. For since the communication path 140 of the extension block 120 has a structural feature of extending long downwards from the lower end of the main body 110 and it is where the heterogeneous mixture coating solution is congested most and closet to the coating solution discharge hole 131, it can maintain the dispersing state of powder to the coating solution discharge hole 131 most effectively.

On the other hand, the plunger 160 is preferably formed in a planar form, at the center of which the needle valve through-hole 160a is formed, so as to generate the fluid resistance effectively.

In such a case, the plunger 160 comprises an outer diameter surface (161) encountering closely an inner diameter surface of the communication path (140) and a separating portion (162) forming a separating gap with respect to the inner diameter surface of the communication path (140). Also, the separating portion 162 is preferably formed symmetrically when viewing the plunger 160 in a plan view, so that even magnitude of the fluid resistance is applied to the plunger 160.

The plunger 160 formed as in the above moves through sliding stably along the communication path 140 through the outer diameter surface 161 and at the same time provides a path through which the heterogeneous mixture coating solution in the communication path 140 moves up and down through the separating gap formed by the separating portion 162. As a result, if the needle valve 150 performs the pulse opening and closing operations, the plunger 160 moves up and down along the needle valve 150, and as a vortex is generated around the plunger 160 in the process, stirring of powder can be obtained actively.

Furthermore, since the plunger 160 is installed close to the floor side of the communication path 140 and moves in sliding stably in a state close to the inner diameter surface of the plunger 160, the needle valve 150 does not shake from side to side even when performing pulse opening and closing operations in a high speed. Therefore, the pulse opening and closing operations of the needle valve 150 is done precisely.

On the other hand, the shape of the separating portion 162 does not have to be limited, but the number and size of the separating portion 162 can be changed appropriately according to the speed of the pulse opening and closing operations of the needle valve 150, which is set by the required magnitude of stirring. That is, the magnitude of fluid resistance can be adjusted by adjusting the number and size of the separating portion 162 in proportion to the speed of pulse opening and closing operations of the needle valve 150.

Even though not shown, the plunger 160 may be formed with a disc having an outer diameter smaller than the inner diameter of the communication path 140, so as to form a separating gap with respect to the inner diameter of the communication path 140 along the entire edge.

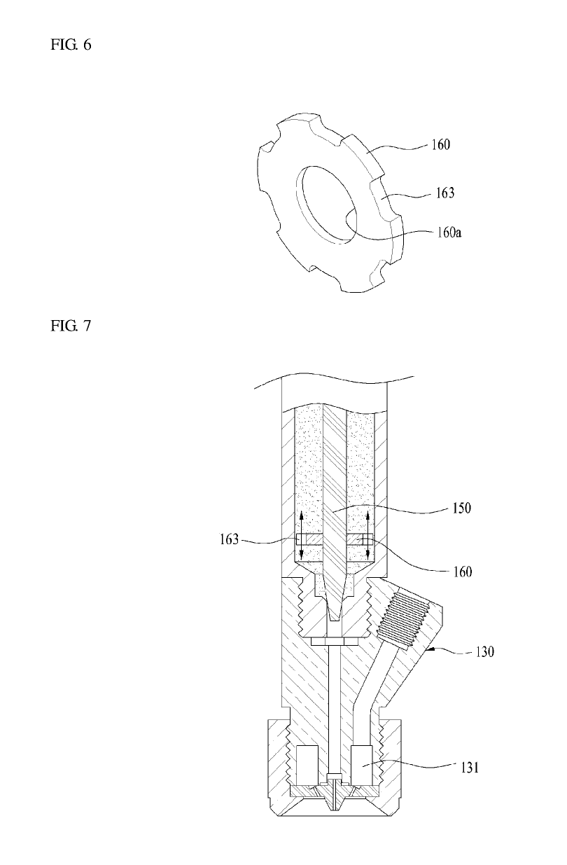

As shown in FIGS. 6 and 7, as another embodiment of the plunger, the plunger 160 is formed with a disc having an outer diameter surface close to the inner diameter surface of the communication path 140 so as to move in sliding stably along the communication path 140, and in the plunger 160 may be formed at least one or more groove portions (163). The groove portion 163 provides a path through which the heterogeneous mixture coating solution in the communication path 140 moves up and down. The groove portion 163 can be preferably formed with a given interval along the outer diameter surface of the plunger 160 that is farthest from the center of the needle valve 150 in order to maximize the generating of the vortex.

On the other hand, the shape and location of the groove portion 163 does not have to be limited, but the number and size of the groove portion 163 may be changed appropriately according to the speed of the pulse opening and closing operations of the needle valve 150, which is set by the required magnitude of stirring. That is, the magnitude of the fluid resistance can be adjusted as adjusting the number and size of the groove portion 163 in proportion to the opening and closing speed of the needle valve 150.

Like this, even though the preferred embodiments of the invention have been described, the invention is not limited by the embodiments in the above, one skilled in the field of technology may be able to modify without leaving the spirit of the invention, and such modifications will belong to the scope of right of the invention.

1. An air spray device for heterogeneous mixture coating solution, using pulse opening and closing operations of needle valve, the air spray device comprising:
a main body provided with a heterogeneous mixture coating solution inlet and a compressed air inlet from outside;
an extension block engaged with a lower end of the main body in a form extending downwards;
a nozzle assembly engaged with a lower end of the extension block and formed with a discharge hole of coating solution for discharging the heterogeneous mixture coating solution passing the extension block to outside;
a communication path formed vertically at the center of the main body, the extension block, and the nozzle assembly;
a needle valve that is installed in the communication path, receiving rising and falling force from the main body, and performing pulse opening and closing operations for opening and closing the discharge hole for coating solution; and
a plunger formed in a planar form, inserted to the needle valve so as to be disposed close to a floor side of the communication path of the extension block, performing pulse opening and closing operations with the needle valve, and generating fluid resistance in the communication path, so as to stir the heterogeneous mixture coating solution.

2. The air spray device for heterogeneous mixture coating solution, using pulse opening and closing operations of needle valve of claim 1, wherein the plunger comprises an outer diameter surface encountering closely an inner diameter surface of the communication path and a separating portion forming a separating gap with respect to the inner diameter surface of the communication path, so as to adjust magnitude of the fluid resistance.

3. The air spray device for heterogeneous mixture coating solution, using pulse opening and closing operations of needle valve of claim 1, wherein the plunger is a disc with an outer diameter close to the inner diameter surface of the communication path, and
wherein at least one groove portion penetrating for top to bottom is formed in the plunger, so as to adjust magnitude of the fluid resistance.

4. The air spray device for heterogeneous mixture coating solution, using pulse opening and closing operations of needle valve of claim 3, wherein the groove portion is formed so that a plurality of grooves are formed along the outer diameter surface with even intervals.
